(19) United States
(12) Patent Application Publication
(10) Pub. No.: US 2024/0077875 A1
(43) Pub. Date: Mar. 7, 2024

(54) ROBOT AND METHOD FOR ROBOT POSITIONING

(71) Applicant: Shenzhen Pengxing Intelligent Research Co., Ltd., Shenzhen (CN)

(72) Inventors: ZHI-GUANG XIAO, Shenzhen (CN); SI-BO LAI, Shenzhen (CN); MING-HUI GU, Shenzhen (CN); ZHI-CHANG QIU, Shenzhen (CN); WEI-LIN LIN, Shenzhen (CN)

(21) Appl. No.: 18/238,118

(22) Filed: Aug. 25, 2023

(30) Foreign Application Priority Data
Sep. 2, 2022 (CN) 202211069393.2

(51) Int. Cl. G05D 1/02

(52) U.S. Cl. CPC G05D 1/0219

(57) ABSTRACT

The present disclosure provides a positioning method, including: obtaining a current local topology map established based on objects in an environment currently observed by a robot, obtaining a full topology map pre-established based on objects in a full environment in a preset area, the current local topology map and the full topology map including nodes representing the objects; matching a node pair to be associated constructed by two nodes in the current local topology map and two nodes in the full topology map; if a degree of association of the node pair to be associated is greater than a threshold, determining that the node pair to be associated is an associated node pair; and determining a pose of the robot according to one of a plurality of search ranches, with a largest number of associated node pairs.

### FIELD

The present disclosure relates to the technical field of robot positioning, and in particular to a robot, a method for robot positioning, and a storage medium.

### BACKGROUND

An initial positioning of a robot indoors is relatively difficult. In an absence of prior positioning, the robot needs to recognize its own pose in a full map. In related technologies, the positioning of the robot usually requires traversing all data in a database, which results in a decrease in positioning efficiency.

### BRIEF DESCRIPTION OF THE DRAWINGS

The above and/or additional aspects and advantages of the present disclosure will become apparent and comprehensible from the description of the embodiments in conjunction with the following drawings:

FIG. 1 is a schematic diagram of a hardware structure of a robot provided by some embodiments of the present disclosure;

FIG. 2 is a schematic diagram of a structural of the robot provided by some embodiments of the present disclosure;

FIG. 3 is a schematic diagram of a flowchart of a positioning method provided by an embodiment of the present disclosure;

FIG. 4 is a schematic diagram of a flowchart of generating a full topology map provided by an embodiment of the present disclosure;

FIG. 5 is a schematic diagram of a current local topology map and a full topology map provided by an embodiment of the present disclosure;

FIG. 6 is a schematic diagram of a flowchart of determining a current pose of the robot provided by an embodiment of the present disclosure;

FIG. 7 is a schematic diagram of a search interpretation tree provided by an embodiment of the present disclosure;

FIG. 8 is a schematic diagram of obtaining a updated full topology map provided by an embodiment of the present disclosure.

### DETAILED DESCRIPTION

To more clearly understand the present disclosure, some definitions of selected terms employed in the embodiment are given. The definitions include various examples and/or forms of components that fall within the scope of a term and that may be used for implementation. The examples are not intended to be limiting. Furthermore, the components discussed herein, may be combined, omitted, or organized with other components or into different architectures.

It should be noted that, in this disclosure, “at least one” refers to one or more, and “a plurality of” refers to two or more than two. “And/or” refers to an association relationship between associated objects, representing that three relationships may exist. For example, A and/or B may include a case where A exists separately, A and B exist simultaneously, and B exists separately. Wherein A and B may be singular or plural. The terms “first”, “second”, “third”, “fourth”, etc. in the description and claims and drawings of the disclosure are used for distinguishing similar objects, rather than for describing a specific sequence or order.

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

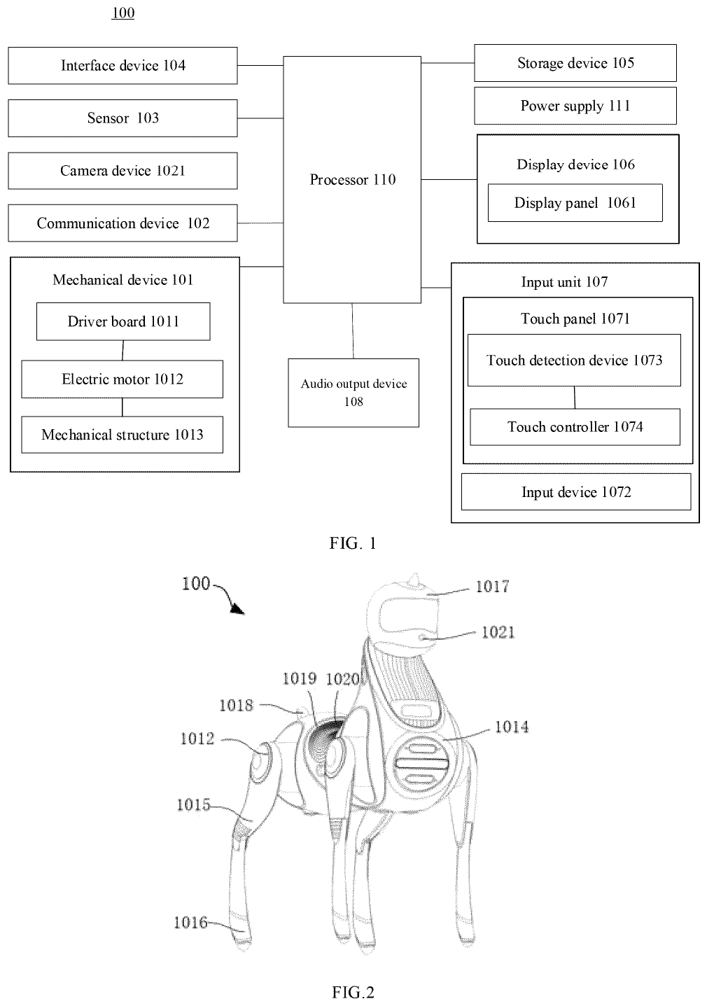

FIG. 1 is a schematic diagram of a robot 100 provided by an embodiment of the present disclosure. In at least one embodiment, the robot 100 can be a legged robot, and the robot 100 may include a mechanical device 101, a communication device 102, at least one sensor 103, an interface device 104, a storage device 105, a processor 110, and a power supply 111. The various components of the robot 100 may be connected in any manner, including by wired or wireless connections and the like. Those skilled in the art can understand the specific structure of the robot 100 shown in FIG. Components are not essential components of the robot 100 and can be omitted or combined according to needs without changing the essence of the application.

The various components of the robot 100 are specifically introduced below in conjunction with FIG. 1:

The mechanical device 101 is part of the hardware of the robot 100. As shown in FIG. 1, the mechanical device 101 may include a driver board 1011, at least one electric motor 1012, and a mechanical structure 1013, as shown in FIG. 2. The mechanical structure 1013 may include a main body 1014, an extendable leg 1015, and at least one foot 1016. In other embodiments, the mechanical structure 1013 may also include an extendable robotic arm (not shown), a rotatable head structure 1017, a wagable tail structure 1018, a load structure 1019, a saddle structure 1020, a camera device 1021, and so on. The robot 100 can take pictures through the camera device 1021, so as to obtain visual information. It should be noted that each component of the mechanical device 101 can be one or more and can be set according to specific conditions. For example, the mechanical device 101 may include four legs 1015, and each leg 1015 can be equipped with three electric motors 1012. Then, the mechanical device 101 may include twelve electric motors 1012.

The communication device 102 may receive and send signals and may also communicate with the network and other devices. For example, after the communication device 102 receives command sent by a remote controller or other robot 100 to move in a predetermined direction at a predetermined speed according to a predetermined gait, the communication device 102 transmits the command to the processor 110. The communication device 102 includes, for example, a Wi-Fi device, a 4G device, a 5G device, a Bluetooth, an infrared device, and the like.

The at least one sensor 103 acquires information of a surrounding environment of the robot 100 and monitors parameters of the components of the robot 100 and sends the information and the parameters to the processor 110. The at least one sensor 103 for acquiring surrounding environment information includes a laser radar (for long-range object detection, distance determination and/or speed value determination), a millimeter-wave radar (for short-range object detection, distance determination and/or or speed value), a camera, an infrared camera, a full Navigation Satellite System (full Navigation Satellite System, GNSS), etc. The at least one sensor 103 for monitoring parameters of the components of the robot 100 includes an inertial measurement module (Inertial Measurement Module, IMU) (for measuring the value of velocity value, acceleration value and angular velocity value), a plantar sensor (for monitoring a position of a plantar force point, a foot posture, a ground contact force size and direction), a temperature sensor (used to detect component temperature). As for other sensors such as load sensors, touch sensors, motor angle sensors, and torque sensors that can be configured on the robot 100 will not be introduced here.

The interface device 104 receives information (e.g., data information, power, etc.) from an external device and sends the received information to one or more components of the robot 100. The interface device 104 may include a power port, a data port such as a USB port, a memory card port, a port for connecting a device with an identification device, an audio input/output (I/O) port, a video I/O port, and the like.

The storage device 105 stores software programs and various data. The storage device 105 can mainly include a program storage state and a data storage state. The program storage state can store operating system programs, motion control programs, application programs (such as text editors), etc. The data storage state can store data generated by the robot 100 when the robot 100 is working (such as various sensing data acquired by the at least one sensor 103, log file data) and the like. In addition, the storage device 105 may include a high-speed random-access memory, and may also include a non-volatile memory, such as a magnetic disk memory, a flash memory, or other volatile solid-state memory.

The display device 106 displays information input by a user or information provided to the user. The display device 106 may include a display panel 1061, and the display panel 1061 may include a liquid crystal display (Liquid Crystal Display, LCD), an organic light-emitting diode (Organic Light-Emitting Diode, OLED), or the like.

The input unit 107 can receive numeric or character information. Specifically, the input unit 107 may include a touch panel 1071 and other input devices 1072. The touch panel 1071, also referred to as a touch screen, can collect touch operations (for example, operations input on the touch panel 1071 or near the touch panel 1071 by palms or fingers of the user, or accessories). The touch panel 1071 may include two parts, a touch detection device 1073 and a touch controller 1074. The touch detection device 1073 detects the user's touch orientation, detects the signal generated by the touch operation, and transmits the signal to the touch controller 1074. The touch controller 1074 receives the touch information from the touch detection device 1073, and converts the touch information into point coordinates, and sends the point coordinates to the processor 110. The touch processor 110 receives and executes commands sent by the processor 110. In addition to the touch panel 1071, the input unit 107 may also include other input devices 1072. Specifically, other input devices 1072 may include, but are not limited to, one or more of remote controller handles, etc., which are not specifically limited here.

Further, the touch panel 1071 includes a display panel 1061, and when the touch panel 1071 detects a touch operation on or near the touch panel 1071. The touch panel 1071 transmits the signal generated by the touch operation to the processor 110 to determine a type of the touch operation, and then the processor 110 control the display panel 1061 to provide a corresponding visual output according to the determined type of the touch operation. In FIG. 1, the touch panel 1071 and the display panel 1061 are used as two independent components to realize the input and output functions respectively, in some embodiments, the touch panel 1071 and the display panel 1061 can be integrated to realize the input and output functions are not limited here.

The audio output device 108 may convert audio data received by the communication device 102 or stored in the storage device 105 into an audio signal and output as sound. The audio output device 108 may include a speaker, a buzzer, and the like.

The processor 110 is a control center of the robot 100. The processor 110 uses various interfaces and lines to connect the various parts of the robot 100 and controls the robot 100 by running or executing the software program stored in the storage device 105, and by calling the data stored in the storage device 105.

The power supply 111 supplies power to various components of the robot 100. The power supply 111 may include a battery and a power control board. The power control board is used to control functions such as battery charging, discharging, and power consumption management. In the embodiment shown in FIG. 1, the power supply 111 is electrically connected to the processor 110. In other embodiments, the power supply 111 can also be electrically connected to the at least one 103 (such as a camera, radar, speaker, etc.) and the at least one electric motor 1012. It should be noted that each component may be connected to different power supply 111 or powered by the same power supply 111.

According to the above embodiments, specifically, in some embodiments, a terminal device is communicated with the robot 100. The terminal device sends instructions to the robot 100, and the robot 100 receives the instructions from the communication device 102 and transmits them to the processor 110. The processor 110 obtains a target speed according to the instructions. The terminal device includes, but is not limited to, mobile phones, tablet computers, servers, personal computers, wearable smart devices, and other electrical equipment with image capture functions.

The instructions are set by preset conditions. In one embodiment, the robot 100 includes at least one sensor 103, and at least one sensor 103 generates instructions according to the current environment in which the robot 100 is located. The processor 110 determines whether the current speed of the robot 100 satisfies a corresponding preset condition according to the instructions. In response to the fact that the current speed satisfies the corresponding preset condition, the processor 110 controls the robot 100 to move according to the current speed and a current gait. In response to the fact that the current speed does not satisfy the corresponding preset condition, the processor 110 determines the target speed and the corresponding target gait according to the corresponding preset conditions and controls the robot 100 to move according to the target speed and the corresponding target gait. The at least one sensor 103 includes temperature sensors, air pressure sensors, visual sensors, and sound sensors. The instruction includes temperature information, air pressure information, image information, and sound information. A communication mode between the at least one sensor 103 and the processor 110 may be wired communication or wireless communication. Ways of wireless communication include, but are not limited to, wireless networks, mobile communication networks (3G, 4G, 5G, etc.), Bluetooth, and infrared.

The initial positioning of the robot indoors is usually a relatively difficult challenge. In the absence of prior positioning, the robot needs to recognize its precise pose in a full map through its own sensor information at a current moment. A visual bag of words model is one of the popular methods to solve the initial positioning of the robot. It uses image information extraction and clustering ORB feature descriptors to construct a visual dictionary, and uses a similarity of visual words to match a query image with a most similar image in a database, so as to find a full pose corresponding to the robot. This technical solution has obvious shortcomings, such as feature points being low-layer local image descriptors, are easily affected by lighting, rotation angles, and moving objects; limited by a field of view of the camera device of the robot, it is not easy to match different viewing angles at a same position; the efficiency is low, and it is necessary to traverse all the data in the database, and the efficiency decreases as map data becomes larger.

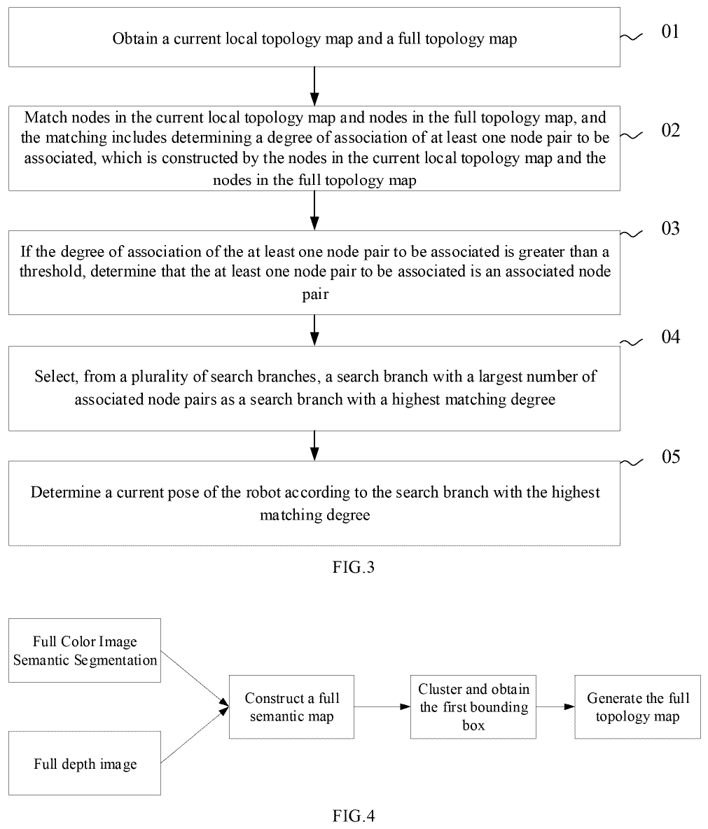

Referring to FIG. 1 to FIG. 3, the positioning method provided by the embodiment of the present disclosure can be applied to the robot 100. According to different requirements, an order of each block in the flowchart of the positioning method can be adjusted according to actual detection requirements, and some blocks can be omitted. In at least one embodiment, the positioning method can include the following blocks.
Block 01, the robot 100 obtains a current local topology map and a full topology map, the current local topology map is established based on objects in an environment currently observed by the robot 100, the full topology map is pre-established based on objects in a full environment in a preset area, the current local topology map includes nodes representing the objects in the environment currently observed by the robot 100, and the full topology map includes nodes representing the objects in the full environment;
Block 02, the robot 100 matches the nodes in the current local topology map and the nodes in the full topology map, and the matching includes determining a degree of association of at least one node pair to be associated, which is constructed by the nodes in the current local topology map and the nodes in the full topology map;
Block 03, if the degree of association of the at least one node pair to be associated is greater than a threshold, the robot 100 determines that the at least one node pair to be associated is an associated node pair;
Block 04, the robot 100 selects, from a plurality of search branches, a search branch with a largest number of associated node pairs as a search branch with a highest matching degree;
Block 05, the robot 100 determines a current pose of the robot 100 according to the search branch with the highest matching degree.

The positioning method of the embodiment of the present disclosure can be realized by the robot 100 of the embodiment of the present disclosure. Specifically, please refer to FIG. 1, the processor 110 is used to: obtain a current local topology map and a full topology map, the current local topology map is established based on objects in an environment currently observed by the robot 100, the full topology map is pre-established based on objects in a full environment in a preset area, the current local topology map includes nodes representing the objects in the environment currently observed by the robot 100, and the full topology map includes nodes representing the objects in the full environment; match the nodes in the current local topology map and the nodes in the full topology map, and the matching includes determining a degree of association of at least one node pair to be associated, which is constructed by the nodes in the current local topology map and the nodes in the full topology map; if the degree of association of the at least one node pair to be associated is greater than a threshold, determine that the at least one node pair to be associated is an associated node pair; select, from a plurality of search branches, a search branch with a largest number of associated node pairs as a search branch with a highest matching degree; determine a current pose of the robot 100 according to the search branch with the highest matching degree.

The above positioning method and the robot 100 can quickly and accurately determine associated node pairs (i.e., associated object pairs) through topology map matching, therefore, the search branch with the highest matching degree can be quickly determined through the number of associated nodes with the largest number of associated node pairs in the current local topology map and the full topology map, and then the current pose of the robot 100 can be determined according to the search branch with the highest matching degree.

The current local topology map is established according to the at least one object in the current environment detected by the robot 100, the at least one object in the current environment detected by the robot 100 refers to the at least one object in the environment detected when the robot 100 is in the current pose.

The full topology map is pre-established according to the at least one object in the full environment in the preset area, the preset area can be any preset area, for example, the preset area can be an indoor area, specifically all areas of an entire building, or one of floors, or one of rooms, etc., are not specifically limited here.

Among them, the node in the current local topology map and the node in the full topology map are matched, and the degree of association of the at least one node pair to be associated can be determined according to a matching result. If the degree of association of the at least one node pair to be associated is greater than the threshold, it means that two nodes of the at least one node pair to be associated are related. Therefore, the at least one node pair to be associated can be determined as an associated node pair. Among them, the threshold may be preset, and is not specifically limited here.

The current local topology map and the full topology map can form a plurality of search branches, when the number of associated node pairs in each of the plurality of search branches is determined, and the search branch with the largest number of associated node pairs is determined, then the current pose of the robot 100 can be determined according to the search branch with the highest matching degree. This disclosure transforms a positioning problem of the robot 100 into a matching problem between topology maps, and can quickly and accurately determine the search branch with the highest matching degree through the topology map matching, thereby quickly and accurately determining the current pose of the robot 100. Among them, the current pose of the robot 100 may refer to an initial pose at a current moment, the initial pose means that the robot 100 has no prior positioning (no positioning information earlier than the current moment), and the pose may refer to the position and a posture (orientation).

In some embodiments, the obtaining of the full topology map at block 01, includes:
Block 011, the robot 100 obtains a full environment image and a full depth image;
Block 012, the robot 100 establishes a full semantic map based on the full environment image and the full depth image, the full semantic map includes full point cloud information and first object type labels corresponding to the full point cloud information;
Block 013, the robot 100 clusters the full point cloud information in the full semantic map according to the first object type labels, identifies each object, and obtains a first bounding box of each object, the first bounding box is an independent space corresponding to point clouds with same first object type label after clustering the point clouds;
Block 014, the robot 100 takes each first bounding box as a node, and takes a connection line between two adjacent first bounding boxes as an edge to generate the full topology map, a distance between the two adjacent first bounding boxes is less than a preset distance.

The positioning method of the embodiment of the present disclosure can be realized by the robot 100 of the embodiment of the present disclosure. Specifically, please refer to FIG. 1, the processor 110 is used to: obtain a full environment image and a full depth image captured by the camera device 1021; establish a full semantic map based on the full environment image and the full depth image, the full semantic map includes full point cloud information and first object type labels corresponding to the full point cloud information; cluster the full point cloud information in the full semantic map according to the first object type labels, identifies each object, and obtains a first bounding box of each object, the first bounding box is an independent space corresponding to point clouds with same first object type label after clustering the point clouds; take each first bounding box as a node, and take a connection line between two adjacent first bounding boxes as an edge to generate the full topology map, a distance between the two adjacent first bounding boxes is less than a preset distance.

In this way, the full topology map can be generated based on object semantics.

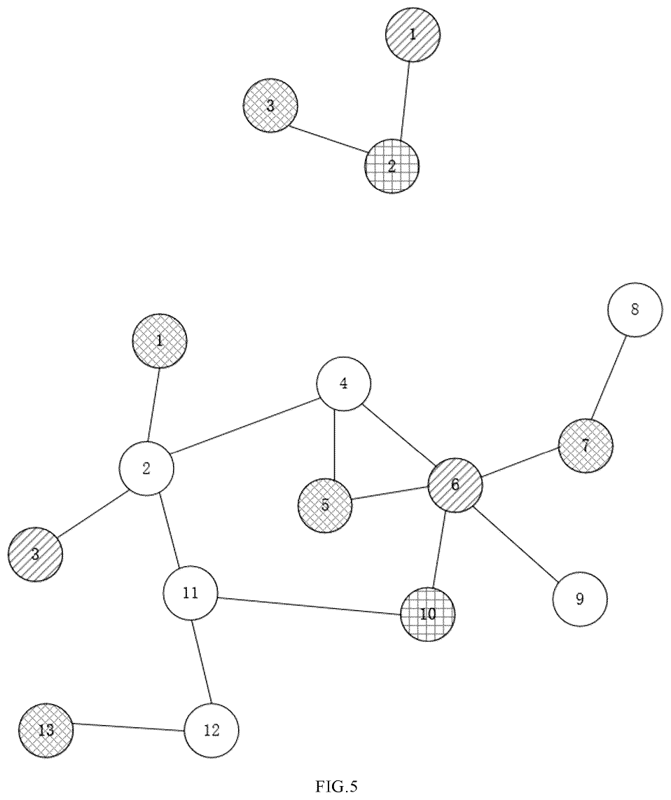

Referring to FIG. 4, the full topology map may be pre-established in an offline stage (not a stage of determining the current pose of the robot 100). Specifically, under an action of a visual odometry, the robot 100 can walk around the full environment in the preset area, and obtain the full environment image (the full environment image can be a RGB three-channel environment image, and the camera device 1021 can be a visible light camera) and the full depth image (depth image is similar to a grayscale image, except that each pixel value of the depth image is an actual distance between the sensor and the object, and the camera device 1021 can be a structured light camera, a TOF camera, etc.) through the camera device 1021, among them, the full environment image and the full depth image can be registered, and there is a one-to-one correspondence relationship between pixels of the full environment image and the full depth image. A full semantic map is constructed by using the full environment image and the full depth image, and the full semantic map includes full point cloud information and first object type labels corresponding to the full point cloud information. Among them, the full environment image is subjected to object semantic segmentation through a trained network, combined with the full depth image, semantic and point clouds are reconstructed in 3D, thus forming a 3D full semantic map. Segmented objects can be building structures such as walls, corner lines, sofas, air conditioners, refrigerators and other objects that are not easy to move. The full point cloud information in the full semantic map is clustered according to the first object type labels, that is, the point clouds with the same first object type label are clustered. Among them, the point clouds with the same first object type label and are similar to each other may be clustered, so as to identify each object. For example, there are two stools in the full environment in the preset area, and labels of the two stools are both stools. Bounding boxes can be distinguished according to the distance between the point clouds, and the point clouds corresponding to the same stool are clustered. A centroid of each object is calculated, and the first bounding box and six-degree-of-freedom coordinates of each object are obtained through the trained model, the first bounding box is the independent space corresponding to point clouds with same first object type label after clustering the point clouds (specifically, the independent space can be a sphere, a cuboid, etc., and the embodiment of the present application takes the independent space as a cuboid as an example for illustration, for example, the bounding box is a smallest cuboid in the space that encloses the point clouds of the same object label), among them, the first bounding box is a directed bounding box (that is, the first bounding box can be rotated arbitrarily according to the first-order moment of the object). A coordinate origin of the six-degree-of-freedom coordinates of the object may be a center of the bounding box, and a coordinate direction is a three-dimensional vector that is orthogonal to the space defined during labeling.

Taking each first bounding box as a node (taking building structures such as walls, corner lines, sofas, air conditioners, refrigerators and other objects that are not easy to move as nodes), and taking the connection line of two adjacent first bounding boxes as an edge (it can be an undirected edge, the undirected edge refers to an edge without direction, and the undirected edge has no arrow, that is, there is no bounding box pointing to another bounding box), thereby generating the full topology map, among them, if the distance between two first bounding boxes is less than the preset distance, the two first bounding boxes can be considered to be adjacent, so as to form the connection line between the two first bounding boxes and takes the connection line as an edge; if the distance between the two first bounding boxes is greater than the preset distance, the two first bounding boxes can be considered to be not adjacent, the two first bounding boxes are not connected, that is, no edge is generated. Please refer to FIG. 5, for example, if a distance between the bounding box corresponding to node 4 and the bounding box corresponding to node 8 is greater than the preset distance, it can be considered that the two are not adjacent. Node 4 and node 8 are not connected, that is, no edge is generated. Semantically segmented objects are used as features, which have high-layer feature attributes. Compared with low-layer feature descriptors such as visual bag of words, they are not easily affected by illumination and angles; the topology map is constructed through a proximity relationship of objects, which is not affected by the limit of view angle. The topology map is constructed with architectural structures and objects that are not easy to move, and is not affected by objects that are easy to move.

In some embodiments, the obtaining the current local topology map at block 01, includes:
Block 015, the robot 100 obtains a current environment image and a current depth image;
Block 016, the robot 100 establishes a current semantic map according to the current environment image and the current depth image, the current semantic map includes current point cloud information and second object type labels corresponding to the current point cloud information;
Block 017, the robot 100 clusters the current point cloud information in the current semantic map according to the second object type labels, identifies each object, and obtains second bounding box of each object, the second bounding box is an independent space corresponding to point clouds with same second object type label after clustering the point clouds;
Block 018, the robot 100 takes each second bounding box as a node and takes a connection line between two adjacent second bounding boxes as an edge to generate the current local topology map, and a distance between the two adjacent second bounding boxes is less than the preset distance.

The positioning method of the embodiment of the present disclosure can be realized by the robot 100 of the embodiment of the present disclosure. Specifically, please refer to FIG. 1, the processor 110 is used to: obtain a current environment image and a current depth image captured by the camera device 1021; establish a current semantic map according to the current environment image and the current depth image, the current semantic map including current point cloud information and second object type labels corresponding to the current point cloud information; cluster the current point cloud information in the current semantic map according to the second object type labels, identify each object, and obtain second bounding box of each object, the second bounding box is an independent space corresponding to point clouds with same second object type label after clustering the point clouds; take each second bounding box as a node and take a connection line between two adjacent second bounding boxes as an edge to generate the current local topology map, and a distance between the two adjacent second bounding boxes is less than the preset distance.

In this way, the current local topology map can be generated based on object semantics.

Specifically, when the robot 100 is in an unknown position, the current local topology map can be generated. Referring to FIG. 6, the current local topology map may be generated in an online stage (i.e., a stage of determining the current pose of the robot 100). The method of generating the current local topology map is similar to the method of generating the full topology map, and will not be repeated here. Compared with generating the full topology map, when generating the current local topology map, the robot 100 obtains the current environment image and the current depth image by shooting at the current pose.

In some embodiments, block 04 (the robot 100 selects, from the plurality of search branches, the search branch with the largest number of associated node pairs as the search branch with the highest matching degree) includes:
Block 0412, the robot 100 combines the current local topology map and the full topology map to construct a search interpretation tree, the search interpretation tree includes the plurality of search branches, and the robot 100 traverses each of the plurality of search branches;
Block 0414, the robot 100 constitutes a second-layer node using each node in the current local topology map;
Block 0416, the robot 100 takes the second-layer node as a parent node, and constitutes a third-layer node by taking each node in the full topology map as a child node of the second-layer node, the second-layer node and the third-layer node constitutes a first node pair of the search interpretation tree;
Block 0418, the robot 100 determines whether the first object type label corresponding to the node in the full topology map is the same as the second object type label corresponding to the node in the current local topology map in the first node pair;
Block 0422, if the first object type label corresponding to the node in the full topology map is different from the second object type label corresponding to the node in the current local topology map in the first node pair, then the robot 100 ends a construction of the corresponding search branch;
Block 0424, if the first object type label corresponding to the node in the full topology map is the same as the second object type label corresponding to the node in the current local topology map in the first node pair, then the robot 100 takes the third-layer node as the parent node, and constitutes a fourth-layer node by taking all remaining nodes after removing nodes that appeared in an upstream branch of the search branch in the current local topology map as the child nodes of the third-layer node; takes the fourth-layer node as the parent node, and constitutes a fifth-layer node by taking all the remaining nodes in the full topology map after removing the nodes that appeared in the upstream branch of the search branch as the child nodes of the fourth-layer node, and the fourth-layer node and the fifth-layer node constitute the second node pair of the search interpretation tree;
Block 0426, the robot 100 determines whether the first object type label corresponding to the node in the full topology map is the same as the second object type label corresponding to the node in the current local topology map in the second node pair;
Block 0428, according to a distance and an angle between two current local topology map nodes in the first node pair and the second node pair and a distance and an angle between two full topology map nodes in a same search branch, the robot 100 obtains a degree of association of a node pair to be associated formed by the first node pair and the second node pair, the two current local topology map nodes can be defined to be two nodes in the current local topology map, and the two full topology map nodes can be defined to be two node in the full topology map;
Block 0432, if the first object type label corresponding to the node in the full topology map is different from the second object type label corresponding to the node in the current local topology map in the second node pair, or the degree of association is less than the threshold, the robot 100 ends the construction of the corresponding search branch;
Block 0434, if the first object type label corresponding to the node in the full topology map is the same as the second object type label corresponding to the node in the current local topology map in the second node pair, and the degree of association is greater than the threshold, the robot 100 continues to traverse the node of the current local topology map and the full topology map;
Block 0436, the robot 100 counts a number of associated node pairs of each search branch, and determines the search branch with the largest number of associated node pairs as the search branch with the highest matching degree.

The positioning method of the embodiment of the present disclosure can be realized by the robot 100 of the embodiment of the present disclosure. Specifically, please refer to FIG. 1, the processor 110 is used to: combine the current local topology map and the full topology map to construct a search interpretation tree, which includes the plurality of search branches, and traverse each of the plurality of search branches; constitute a second-layer node using each node in the current local topology map; take the second-layer node as a parent node, and constitute a third-layer node by taking each node in the full topology map as a child node of the second-layer node, the second-layer node and the third-layer node constitutes a first node pair of the search interpretation tree; determine whether the first object type label corresponding to the node in the full topology map is the same as the second object type label corresponding to the node in the current local topology map in the first node pair; if the first object type label corresponding to the node in the full topology map is different from the second object type label corresponding to the node in the current local topology map in the first node pair, then end a construction of the corresponding search branch; if the first object type label corresponding to the node in the full topology map is the same as the second object type label corresponding to the node in the current local topology map in the first node pair, then take the third-layer node as the parent node, and constitute a fourth-layer node by taking all remaining nodes after removing nodes that appeared in an upstream branch of the search branch in the current local topology map as the child nodes of the third-layer node; take the fourth-layer node as the parent node, and constitutes a fifth-layer node by taking all the remaining nodes in the full topology map after removing the nodes that appeared in the upstream branch of the search branch as the child nodes of the fourth-layer node, and the fourth-layer node and the fifth-layer node constitute the second node pair of the search interpretation tree; determine whether the first object type label corresponding to the node in the full topology map is the same as the second object type label corresponding to the node in the current local topology map in the second node pair; according to a distance and an angle between two current local topology map nodes and a distance in the first node pair and the second node pair and an angle between two full topology map nodes in a same search branch, obtain a degree of association of a node pair to be associated formed by the first node pair and the second node pair; if the first object type label corresponding to the node in the full topology map is different from the second object type label corresponding to the node in the current local topology map in the second node pair, or the degree of association is less than the threshold, end the construction of the corresponding search branch; if the first object type label corresponding to the node in the full topology map is the same as the second object type label corresponding to the node in the current local topology map in the second node pair, and the degree of association is greater than the threshold, continue to traverse the node of the current local topology map and the full topology map; counts a number of associated node pairs of each search branch, and determine the search branch with the largest number of associated node pairs as the search branch with the highest matching degree.

In this way, the search can be performed while building the search interpretation tree, and the corresponding search branch will not be constructed if the search fails to find a node that meets the requirements.

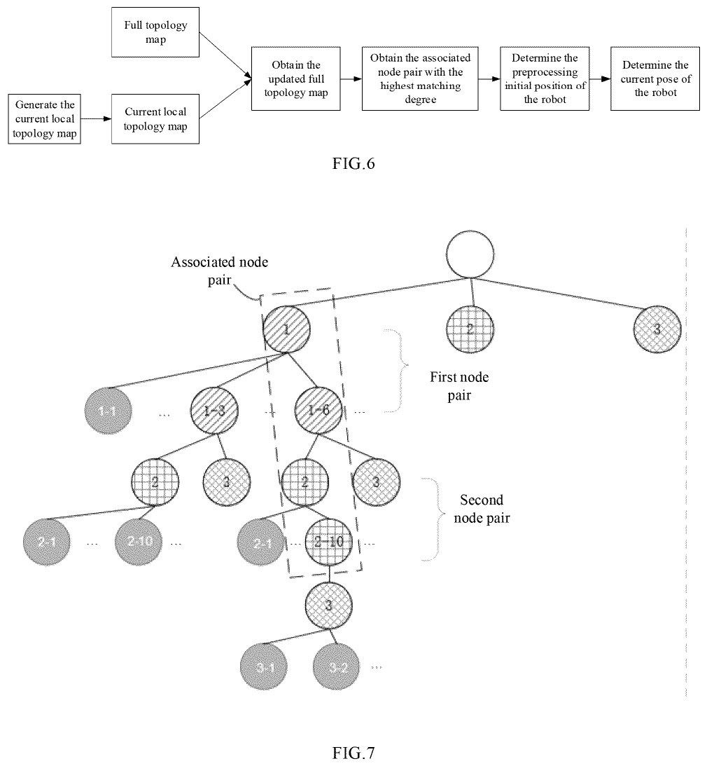

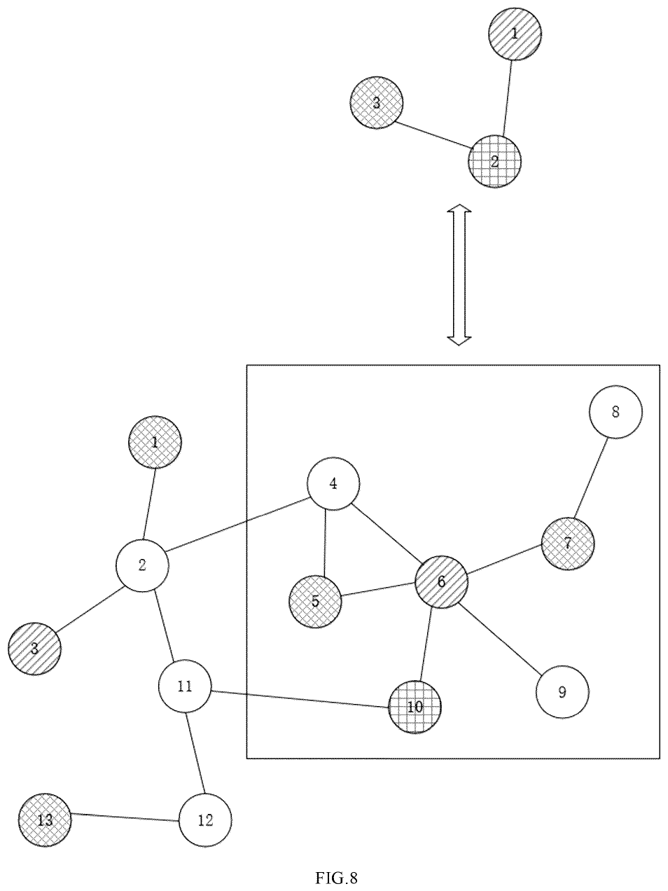

Specifically, the current local topology map and the full topology map are combined to form the search interpretation tree. The search interpretation tree includes the plurality of search branches, and each of the plurality of search branches is traversed to search for search branches meeting conditions, and from the plurality of search branches, selecting the search branch with the largest number of associated node pairs as the search branch with the highest matching degree. More specifically, please refer to FIG. 5. An upper part of FIG. 5 is a current topology diagram, for example, including three nodes in total: node 1, node 2, and node 3. A lower part of FIG. 5 is a full topology map, for example, it includes thirteen nodes in total: node 1, . . . , node 13. Among them, the same filling pattern can be regarded as the same object type label. Please refer to FIG. 7, each node in the current topology diagram constitutes a second-layer node, take the second-layer node as the parent node, and constitute a third-layer node by taking each node in the full topology diagram as the child nodes of the second-layer node, the second-layer node and the third-layer node constitute the first node pair of the search interpretation tree (for example, 1-1, 1-3, 1-10 6 in FIG. 7). Compare an unary constraint between two objects of the first node pair, that is, judge a similarity constraint of a single node: determine whether the first object type label corresponding to the node in the full topology map is the same as the second object type label corresponding to the node in the current local topology map in the first node pair, if the first object type label corresponding to the node in the full topology map is different from the second object type label corresponding to the node in the current local topology map in the first node pair, then it shows that the first node pair is not related to each other, therefore, the construction of the corresponding search branch can be ended, and the search branch will not continue to be constructed (for example, 1-1 in FIG. 7, the object type label of the two are different, and the construction of the corresponding search branch can be terminated). If the first object type label corresponding to the node in the full topology map is the same as the second object type label corresponding to the node in the current local topology map in the first node pair, it means that the first node pair may be related, therefore, it can be continue to construct the search branch (for example, 1-3 and 1-6 in FIG. 7, both have the same object type label, and can continue to build the search branch), that is, take the third-layer node as the parent node, and constitute the fourth-layer of node by taking all remaining nodes after removing the nodes that appeared in the upstream branch of the search branch in the current local topology map as the child nodes of the third-layer node. In one embodiment, if the node that appeared in the second layer is node 1, then node 2 and node 3 constitute the fourth-layer node. Take the fourth-layer node as the parent node, and constitute the fifth-layer node by taking all the remaining nodes after removing the nodes that appeared in the upstream branch of the search branch in the full topology map as the child nodes of the fourth-layer node. In one embodiment, if the node that appears in the third layer is node 6, then the nodes 1-5 and 7-13 constitute the fifth-layer node. The fourth-layer node and the fifth-layer node constitute the second node pair of the search interpretation tree (for example, 2-1, 2-10 in FIG. 7), and the first node pair and the second node pair constitute the node pair to be associated. Among them, it should be noted that the terms “first” and “second” are only used for descriptive purposes, and cannot be understood as indicating or implying relative importance or implicitly indicating the quantity of indicated technical features. For example, the second-layer node in this disclosure may be the second layer or an initial layer, and it is not limited that the first-layer node must be in front of the second-layer node. Specifically, in one embodiment, please refer to FIG. 7, there is a first-layer node in front of the second-layer node, the first-layer node is an empty node, and the empty node can be used as a root node. In another embodiment, there is no first-layer node in front of the second-layer node, and the second-layer node directly serves as the root node.

Compare the unary constraint between the two objects of the second node pair, that is, judge the similarity constraint of a single node: compare whether the first object type label corresponding to the node in the full topology map is the same as the second object type label corresponding to the node in the current local topology map in the second node pair; compare binary constraints between the node pair to be associated, that is, determine the similarity constraints between the two current topology nodes and the two full topology nodes in the first node pair and the second node pair in the same search branch: determine whether two nodes in the current local topology map are connected (whether the topology map has corresponding edge), and whether two nodes in the full topology map are connected, obtain the degree of association of the node pair to be associated according to the distance and the angle between two nodes in the current local topology map and the distance and the angle between two nodes in the full topology map. Among them, the distance and the angle between two nodes in the current local topology map or in the full topology map can be calculated according to the bounding boxes and spatial directions corresponding to the two nodes. The calculation of the distance is, for example: d=|p1−p2|, where, p1 and p2 represent the center points of the two bounding boxes, and the calculation of the angle is, for example, ΔR=|R₁⁻¹·R₂|, where R₁ and R₂ represent rotation matrices of the two bounding boxes relative to the same coordinate system. A rotation matrix R of the bounding box in a certain coordinate system can be obtained using the Rodrigues formula, and a specific method is as follows. Let p be the center point of the bounding box, let px be an intersection of an x-axis of the bounding box and a surface of the bounding box, vector a=p−px, and vector b is a unit vector (1,0,0).

Let v=a×b, s=∥v∥, c=a·b. The rotation matrix R is:

$$\\ R = I + {[ v ]}_{⨯} + {[ v ]}_{⨯}^{2} \frac{1 - c}{{s}^{2}}$$

$$\\ {[ v ]}_{⨯} = [ \begin{matrix}0 & - {v}_{3} & {v}_{2} \\ {v}_{3} & 0 & - {v}_{2} \\ - {v}_{2} & {v}_{1} & 0\end{matrix} ]$$

v1, v2, and v3 represent three values of a three-dimensional vector v. The degree of association of the node pair to be associated is negatively correlated with a difference between the distance between two nodes in the current local topology map and the distance between two nodes in the full topology map. In one embodiment, if the difference is greater than a preset distance difference, it may be considered that the node pair to be associated is not associated with each other. The degree of association of the node pair to be associated is negatively correlated with the difference between the angle between two nodes in the current local topology map and the angle between two nodes in the full topology map.

If the first object type label corresponding to the node in the full topology map is different from the second object type label corresponding to the node in the current local topology map in the second node pair (for example, 2-1 in FIG. 7), it means that the second node pair is not related to each other, and the construction of the corresponding search branch can be ended without continuing to build the search branch. If the two nodes of the current local topology map are not connected, and the two nodes of the full topology map are not connected (for example, in the search branches of 1-3 and 2-10 in FIG. 7, node 3 and node 10 of the full topology map are not connected to each other), or the degree of association of the node pair to be associated is less than the threshold, it means that the degree of association of the node pair to be associated is low, and the node pair to be associated is not an associated node pair, the construction of the corresponding search branch can be ended, and not to continue to construct the search branch. If the first object type label corresponding to the node in the full topology map is the same as the second object type label corresponding to the node in the current local topology map in the second node pair, the two nodes in the current local topology map are connected, and the two nodes in the full topology map are connected, and the degree of association of the node pair to be associated is greater than the threshold, it indicates that the node pair to be associated has a higher degree of association, and the node pair to be associated is the associated node pair (for example, 1-6 and 2-10 in FIG. 7 constitute an associated node pair), traverse other nodes in the current local topology map and the full topology map can be continued to construct the search branch: that is, take the fifth-layer node as the parent node, and construct a sixth-layer node by taking all the remaining nodes after removing the nodes that appeared in the upstream branch of the search branch in the current local topology map as the child nodes of the fifth layer. Take the sixth-layer node as the parent node, and construct a seventh-layer node by taking all the remaining nodes after removing the nodes that appeared in the upstream branch of the search branch in the full topology map as the child nodes of the sixth-layer, and the sixth-layer node and the seventh-layer node constitute the third node pair of the search interpretation tree, the second node pair and the third node pair constitute the node pair to be associated, and so on. The third node pair may be generated when traversing the nodes of the current local topology map and the full topology map, and this is only for the convenience of further description of the solution, and should not be understood as a limitation on the claims.

The number of associated node pairs of each search branch is counted, and the search branch with the largest number of associated node pairs is regarded as the search branch with the highest matching degree.

In some embodiments, before block 04 (the robot 100 selects, from the plurality of search branches, the search branch with the largest number of associated node pairs as the search branch with the highest matching degree), the positioning method includes:
Block 061, the robot 100 combines the current local topology map and the full topology map to construct the search interpretation tree;
Block 062, the robot 100 takes each node in the current local topology map as the second-layer node;
Block 063, the robot 100 takes the second-layer node as the parent node, and construct the third-layer node by taking each node in the full topology map as the child nodes of the second-layer node;
Block 064, the robot 100 takes the third-layer node as the parent node, and constructs the fourth-layer node by taking all the remaining nodes after removing the nodes that appeared in the upstream branch of the search branch in the current local topology map as the child nodes of the third-layer node;
Block 065, the robot 100 takes the fourth-layer node as the parent node, and constructs the fifth-layer node by taking all remaining nodes after removing the nodes that appeared in the upstream branch of the search branch in the full topology map as the child nodes of the fourth-layer node;
Block 066, by analogy, the robot 100 continues to traverse the nodes of the current local topology map and the full topology map to construct the search interpretation tree.

The positioning method of the embodiment of the present disclosure can be realized by the robot 100 of the embodiment of the present disclosure. Specifically, referring to FIG. 1, the processor 110 is configured to: combine the current local topology map and the full topology map to construct the search interpretation tree; take each node in the current local topology map as the second-layer node; take the second-layer node as the parent node, and construct the third-layer node by taking each node in the full topology map as the child nodes of the second-layer node; take the third-layer node as the parent node, and construct the fourth-layer node by taking all the remaining nodes after removing the nodes that appeared in the upstream branch of the search branch in the current local topology map as the child nodes of the third-layer node; take the fourth-layer node as the parent node, and constructs the fifth-layer node by taking all remaining nodes after removing the nodes that appeared in the upstream branch of the search branch in the full topology map as the child nodes of the fourth-layer node; by analogy, continue to traverse the nodes of the current local topology map and the full topology map to construct the search interpretation tree.

In this way, a complete search interpretation tree can be constructed first based on the current local topology map and the full topology map, and then associated node pairs can be searched based on the complete search interpretation tree.

Specifically, the complete search interpretation tree is constructed according to the current local topology map and the full topology map. Each node in the current local topology map constitutes the second-layer node, take the second-layer node as the parent node, and construct the third-layer node by taking each node in the full topology map as a child node of the second-layer node. Take the third-layer node as the parent node, constitute the fourth-layer nodes by taking all the remaining nodes after removing the nodes that appeared in the upstream branch of the search branch in the current local topology map as the child nodes of the third-layer. Take the fourth-layer node as the parent node, and constitute the fifth-layer node by taking all the remaining nodes after removing the nodes that appeared in the upstream branch of the search branch in the full topology map as the child nodes of the fourth layer. By analogy, continue to traverse other nodes of the current local topology map and the full topology map to form the search interpretation tree. Each search branch is a complete node matching pair, and all search branches constitute all possible situations of the node pairs to be associated. Among them, it should be noted that the terms “first” and “second” are only used for descriptive purpose, and cannot be understood as indicating or implying relative importance or implicitly indicating the quantity of indicated technical features. For example, the second-layer node in this application may be the second layer or the initial layer, and it is not limited that the first-layer node must be in front of the second-layer node. Specifically, in an embodiment, the second-layer node is preceded by a first-layer node, the first-layer node is an empty node, and the empty node may be used as a root node. In another embodiment, there is no first-layer node in front of the second-layer node, and the second-layer node directly serves as the root node.

In some embodiments, block 02 (the robot 100 matches the nodes in the current local topology map and the nodes in the full topology map, and the matching including determining a degree of association of at least one node pair to be associated, which is constructed by the nodes in the current local topology map and the nodes in the full topology map), includes:
Block 022, the robot 100 determines whether a first node of the current local topology map and to first node of the full topology map belong to the same object type label, and the first node of the current local topology map and the first node of the full topology map construct a first node pair;
Block 024, if the first node of the current local topology map and the first node of the full topology map belong to the same object type label, then the robot 100 determines whether a second node of the current local topology map and a second node of the full topology map belong to the same object type label, and the second node of the current local topology map and the second node of the full topology map construct a second node pair;
Block 026, if the second node of the current local topology map and the second node of the full topology map belong to the same object type label, the robot 100 compares a distance and an angle between the first node of the current local topology map and the second node of the current local topology map with a distance and an angle between the first node of the full topology map and the second node of the full topology map, and obtains the degree of association of the node pair to be associated constructed by the first node pair and the second node pair. If the degree of association is greater than a threshold, the robot 100 determines the node pair to be associated as an associated node pair.

The positioning method of the embodiment of the present disclosure can be realized by the robot 100 of the embodiment of the present disclosure. Specifically, please refer to FIG. 1, the processor 110 is used to: determine whether a first node of the current local topology map and to first node of the full topology map belong to the same object type label, and the first node of the current local topology map and the first node of the full topology map construct a first node pair; if the first node of the current local topology map and the first node of the full topology map belong to the same object type label, then determine whether a second node of the current local topology map and a second node of the full topology map belong to the same object type label, and the second node of the current local topology map and the second node of the full topology map construct a second node pair; if the second node of the current local topology map and the second node of the full topology map belong to the same object type label, compare a distance and an angle between the first node of the current local topology map and the second node of the current local topology map with a distance and an angle between the first node of the full topology map and the second node of the full topology map, and obtains the degree of association of the node pair to be associated constructed by the first node pair and the second node pair; if the degree of association is greater than a threshold, determine the node pair to be associated as an associated node pair.

In this way, the degree of association of the node pair to be associated can be obtained according to the object type label, the distance and the angle between the nodes.

Specifically, the matching of the node pair to be associated includes comparing the unary constraint between two objects and comparing the binary constraints between the node pair to be associated. Compare the unary constraint between two objects, that is, judge a similarity constraint of a single node: compare whether the second object type label of the first node of the current local topology map is the same as the first object type label of the first node of the full topology map. If the second object type label of the first node of the current local topology map is different from the first object type label of the first node of the full topology map, it means that the first node pair is not related to each other; if the second object type label of the first node of the current local topology map is the same as the first object type label of the first node of the full topology map, compare whether the second object type label of the second node of the current local topology map is the same as the first object type label of the second node of the full topology map. The degree of association is determined by the distance and the angle between nodes. Compare the binary constraints between the node pair to be associated, that is, judge the similarity constraint between two nodes in the current local topology map and two nodes in the full topology map: judge whether the two nodes in the current local topology map are connected (whether the topology map has the corresponding edge), whether the two nodes in the full topology map are connected, and obtain the degree of association of the node pair to be associated according to the distance and the angle between the two nodes in the current local topology map and the distance and angle between the two nodes in the full topology map. Among them, the distance and the angle between two nodes in the current local topology map or in the full topology map can be calculated according to the bounding boxes and spatial directions corresponding to the two nodes. The calculation of the distance is, for example: d=|p1−p2|, where p1 and p2 represent the center points of the two bounding boxes, and the calculation of the angle is, for example: ΔR=|R₁⁻¹·R₂|, where R₁ and R₂ represent the rotation matrices of the two bounding boxes relative to the same coordinate system.

Through the topology map matching, the connection between objects (object type labels, whether nodes are connected, the distance and the angle between nodes) can be compared to obtain associated node pair (associated objects).

In some implementations, the search interpretation tree includes a plurality of search branches. Block 04 (the robot 100 selects, from a plurality of search branches, a search branch with a largest number of associated node pairs as a search branch with a highest matching degree), includes:
Block 0442, the robot 100 traverses each of the plurality of search branches;
Block 0444, if the search branch of the search interpretation tree includes the associated node pair, then the robot 100 determines the search branch as a matching branch (that is, a qualified search branch), otherwise, ends the search of the corresponding search branch;
Block 0446, the robot 100 counts the number of the associated node pairs of each matching branch, and takes the matching branch with the largest number of associated node pairs is taken as the search branch with the highest matching pairs.

The positioning method of the embodiment of the present disclosure can be realized by the robot 100 of the embodiment of the present disclosure. Specifically, please refer to FIG. 1, the processor 110 is used to: traverse each of the plurality of search branches; if the search branch of the search interpretation tree includes the associated node pair, then determine the search branch as a matching branch (that is, a qualified search branch), otherwise, end the search of the corresponding search branch; count the number of the associated node pairs of each matching branch, and take the matching branch with the largest number of associated node pairs as the search branch with the highest matching pairs.

In this way, the search branch with the highest matching degree can be determined by traversing the search interpretation tree.

Specifically, for example, a depth-first traversal method may be used to traverse each search branch of the search interpretation tree. If the second object type label of a single node of the current local topology map is different from the first object type label of a single node of the full topology map, the search of the corresponding search branch can be ended; if the two nodes of the current local topology map are not connected, the two nodes of the full topology map are not connected, or the degree of association of the node pair to be associated is less than a threshold, it indicates that the degree of association of the node pair to be associated is low, and the node pair to be associated is not an associated node pair, and the search of the corresponding search branch can be ended; if the second object type label of the single node in the current local topology map is the same as the first object type label of the single node in the full topology map, two nodes in the current local topology map are connected, two nodes in the full topology map are connected, and the degree of association of the node pair to be associated is greater than the threshold, it indicates that the degree of association of the node pair to be associated is high, and the node pair to be associated is an associated node pair. The corresponding search branch can be determined as the matching branch and continue to traverse the search branch to determine all associated node pairs. The number of associated node pairs of each matching branch is counted, and the matching branch with the largest number of associated node pairs is regarded as the search branch with the highest matching pair.

In some implementations, before block 0412 or block 061 (the robot 100 combines the current local topology map and the full topology map to form a search interpretation tree), the positioning method further includes:
Block 071, the robot 100 calculates a size of the first bounding box of each object in the full topology map and a size of the second bounding box of each object in the current local topology map;
Block 072, the robot 100 counts a number of objects corresponding to the first object type label in the full topology map to determine a first rarity rate and count a number of objects corresponding to the second object type label in the current local topology map to determine a second rarity rate;
Block 073, the robot 100 calculates a first random walk feature of each object in the full topology map and a second random walk feature of each object in the current local topology map;
Block 074, according to the size of the first bounding box, the size of the second bounding box, the first rarity rate, the second rarity rate, the first random walk feature, and the second random walk feature, the robot 100 calculates a similarity of the topology node set of the current local topology map and a similarity of the topology node set of the full topology map, the topology node set includes the first node of the full topology map and the second node of the current local topology map, and the first object type label corresponding to the first node is the same as the second object type label corresponding to the second node;
Block 075, the robot 100 determines a node pair whose similarity in the topology node set is higher than a preset similarity, the robot 100 takes the node of the node pair in the full topology map as a central node, and takes the central node and the nodes within a preset range around the central node in the full topology map as a updated full topology map, and the updated full topology map is used to combine with the current local topology map to construct a search interpretation tree.

The positioning method of the embodiment of the present disclosure can be realized by the robot 100 of the embodiment of the present disclosure. Specifically, please refer to FIG. 1, the processor 110 is used to: calculate a size of the first bounding box of each object in the full topology map and a size of the second bounding box of each object in the current local topology map; count a number of objects corresponding to the first object type label in the full topology map to determine a first rarity rate and count a number of objects corresponding to the second object type label in the current local topology map to determine a second rarity rate; calculate a first random walk feature of each object in the full topology map and a second random walk feature of each object in the current local topology map; according to the size of the first bounding box, the size of the second bounding box, the first rarity rate, the second rarity rate, the first random walk feature, and the second random walk feature, calculate a similarity of a topology node set of the current local topology map and the topology node set, the topology node set includes the first node of the full topology map and the second node of the current local topology map, and the first object type label corresponding to the first node is the same as the second object type label corresponding to the second node; determine a node pair whose similarity in the topology node set is higher than a preset similarity, take the node of the node pair in the full topology map as a central node, and take the central node and the nodes within a preset range around the central node in the full topology map as a updated full topology map, and the updated full topology map is used to combine with the current local topology map to construct a search interpretation tree.

In this way, the full topology map can be pruned according to the size of the bounding box, the rarity rate of the object, and the random walk feature to obtain the updated full topology map. Compared with the original topology map, the updated full topology map has fewer nodes, so that the updated full topology map can be used as an entry for a limited range of topological map matching, to improve the matching efficiency.

Specifically, a distance from the center point of the bounding box to any vertex of the cuboid that constitutes the bounding box can be calculated according to the six-degree-of-freedom coordinates of the object, and the distance can be used as the size of the bounding box. Count the number of various objects to calculate the rarity rate of each kind of objects. For example, if there are 100 objects A in the topology map, the rarity rate of object A is 1/100; if there is only 1 object B in the topology map, the rarity rate of object B is 1. The random walk feature of the object is calculated, and the random walk feature of the object can be b group of walk sequences with length c. Take a current object as a starting point, randomly walking to a connected object is a walk for 1 step, and then randomly walking to a next connected object until c steps are taken, which is a walk. The order of the objects passed is a set of walks with a length of c, and then returns to the starting point and do this b times. For example, an object walks 2 times, each time randomly walking 4 steps towards connected objects.

Calculate the similarity of the topological node set of the current topological graph and the full topological graph through the size of the bounding box, the rarity rate, and the random walk feature, so that the node pair whose similarity in the topological node set is higher than the preset similarity can be found, for example, k node pairs whose similarity is higher than the preset similarity can be found. Among them, the object type labels of the first node and the second node of the topological node set are the same. The node in the full topological map in the node pair with the same object type label and higher similarity than the preset similarity is used as the central node, that is, the first node of the node pair is used as the central node, and the central node and the nodes within the preset range around the central node in the full topological map are used as a updated full topological map. Compared with the original topological map, the number of nodes in the updated full topological map is smaller, so that the updated full topological map can be used as an entry for a limited range of topological map matching, and the matching efficiency can be improved, and then quickly determine the associated node pairs, and determine the current pose of the robot 100 according to the search branch with the highest matching degree, Among them, the surrounding preset range may refer to all nodes within a preset number of steps connected to the central node, among them one edge (one connection) may be considered as one step, and the preset number of steps is, for example, 1, 2, 3, 4, 5, etc., which are not specifically limited here. Please refer to FIG. 8, in one embodiment, the node 1 of the current local topology map and the node 6 of the full topology map are used as a node pair whose similarity is higher than the preset similarity, and the node 6 of the full topology map is used as the central node, and the node 6 and the nodes within the preset range around the node 6 in the full topology map are used as a updated full topology map.

In some embodiments, the associated node pair of the search branch with the highest matching degree is the associated node pair with the highest matching degree. Block 05 (determining the current pose of the robot 100 according to the search branch with the highest matching degree) includes:
Block 052, the robot 100 determines a preprocessing initial position of the robot 100 according to the associated node pair with the highest matching degree;
Block 054, based on the preprocessed initial position, the robot 100 performs point cloud matching on the associated node pair with the highest matching degree, so as to determine the current pose of the robot 100.

The positioning method of the embodiment of the present disclosure can be realized by the robot 100 of the embodiment of the present disclosure. Specifically, please refer to FIG. 1, the processor 110 is configured to: determine a preprocessing initial position of the robot 100 according to the associated node pair with the highest matching degree; based on the preprocessed initial position, perform point cloud matching on the associated node pair with the highest matching degree, so as to determine the current pose of the robot 100.

In this way, the current pose of the robot 100 can be determined through the associated node pair with the highest matching degree.

Specifically, the associated node pair can obtain a preprocessing initial position with a low-precision by combining the trilateration method of the least square method (or other methods such as ransac), among them, the preprocessing initial position has only position information but no attitude information. On the basis of taking the preprocessing initial position as an initial estimate, the point cloud matching is performed on the associated node pair with the highest matching degree, so as to obtain an accurate current pose of six degrees of freedom. Take the point clouds of the associated node pair corresponding to the node of the current topological map as a set of point clouds, and takes the point clouds of the associated node pair corresponding to the node of the full topological map as another set of point clouds, and find an optimal rotation matrix R and a translation t, so that one set of point clouds is transformed and then overlapped with another set of point clouds to the maximum. Among them, determining the preprocessing initial position of the robot 100 according to the associated node pair with the highest matching degree can be regarded as point cloud rough matching, and point cloud rough matching can use SAC-IA (Sample Consensus Initial Alignment, sampling consistency initial alignment algorithm), SAC-IA does not need initial values, and a matching error is relatively large. Based on the preprocessing initial position, point cloud matching is performed on the associated node pair with the highest matching degree, thereby determining the current pose of the robot 100, which can be regarded as point cloud fine matching, and point cloud fine matching can use ICP (Iterative Closest Point, iterative closest point algorithm).

Please refer to FIG. 6 again. In one embodiment, in the online phase, the current local topology map can be generated, and the full topology map can be trimmed according to the current local topology map and the full topology map established in the offline stage to obtain a updated full topology map. The associated node pair with the highest matching degree can be obtained according to the updated full topology map and the current local topology map.

According to an embodiment of the present application, the robot 100 includes a storage device and a processor. The storage device stores a computer program. When the processor executes the computer program, the positioning method in any one of the above-mentioned embodiments is realized. Referring to FIG. 1, in one embodiment, the storage device may be a storage device 105, and the processor may be the processor 110.

For example, when the computer program is executed by the processor, the blocks of the following positioning method are implemented:
Block 01, the robot 100 obtains a current local topology map and a full topology map, the current local topology map is established based on objects in an environment currently observed by the robot 100, the full topology map is pre-established based on objects in a full environment in a preset area, the current local topology map includes nodes representing the objects in the environment currently observed by the robot 100, and the full topology map includes nodes representing the objects in the full environment;
Block 02, the robot 100 matches the nodes in the current local topology map and the nodes in the full topology map, and the matching includes determining a degree of association of at least one node pair to be associated, which is constructed by the nodes in the current local topology map and the nodes in the full topology map;
Block 03, if the degree of association of the at least one node pair to be associated is greater than a threshold, the robot 100 determines that the at least one node pair to be associated is an associated node pair;
Block 04, the robot 100 selects, from a plurality of search branches, a search branch with a largest number of associated node pairs as a search branch with a highest matching degree;
Block 05, the robot 100 determines a current pose of the robot 100 according to the search branch with the highest matching degree.

The above robot 100 can quickly and accurately determine associated node pairs (i.e., associated object pairs) through topology map matching, therefore, the search branch with the highest matching degree can be quickly determined through the number of associated nodes with the largest number of associated node pairs in the current local topology map and the full topology map, and then the current pose of the robot 100 can be determined according to the search branch with the highest matching degree.

A computer-readable storage medium according to an embodiment of the present application, on which a computer program is stored. When the program is executed by the processor, the positioning method in any one of the above-mentioned embodiments is realized.

For example, when the program is executed by the processor, the blocks of the following positioning method are implemented:
Block 01, the robot 100 obtains a current local topology map and a full topology map, the current local topology map is established based objects in an environment currently observed by the robot 100, the full topology map is pre-established based objects in a full environment in a preset area, the current local topology map includes nodes representing the objects in the environment currently observed by the robot 100, and the full topology map includes nodes representing the objects in the full environment;
Block 02, the robot 100 matches the nodes in the current local topology map and the nodes in the full topology map, and the matching includes determining a degree of association of at least one node pair to be associated, which is constructed by the nodes in the current local topology map and the nodes in the full topology map;
Block 03, if the degree of association of the at least one node pair to be associated is greater than a threshold, the robot 100 determines that the at least one node pair to be associated is an associated node pair;
Block 04, the robot 100 selects, from a plurality of search branches, a search branch with a largest number of associated node pairs as a search branch with a highest matching degree;
Block 05, the robot 100 determines a current pose of the robot 100 according to the search branch with the highest matching degree.

The above computer-readable storage medium can quickly and accurately determine associated node pairs (i.e., associated object pairs) through topology map matching, therefore, the search branch with the highest matching degree can be quickly determined through the number of associated nodes with the largest number of associated node pairs in the current local topology map and the full topology map, and then the current pose of the robot 100 can be determined according to the search branch with the highest matching degree.

The computer-readable storage medium can be set on the robot 100 or on other terminal devices, and the robot 100 can communicate with other terminal devices to acquire corresponding computer programs.

It can be understood that the computer-readable storage medium may include: any entity or device capable of carrying a computer program, a recording medium, a USB flash drive, a removable hard disk, a magnetic disk, an optical disk, a computer memory, a read-only memory (ROM), a random access memory (RAM), and a software distribution medium, etc. The computer program includes computer program code. The computer program code may be in form of source codes, in form of object codes, in form of executable file or some intermediate, etc.

Any process or method descriptions in flowcharts or otherwise described herein may be understood to represent modules, segments or portions of code comprising one or more executable instructions for implementing specific logical functions or steps of a process, and the scope of the embodiments of the present disclosure includes additional implementations in which functions may be performed out of an order shown or discussed, including substantially concurrently or in reverse order as the functions involved are understood by those skilled in the art to which embodiments of the present disclosure pertain.

In the description of the present disclosure, descriptions with reference to the terms “one embodiment”, “some embodiments”, “exemplary embodiments”, “example”, “specific examples” or “some examples” mean that a combination of the embodiments or examples describe specific features, structures, materials, or characteristics that are included in at least one embodiment or example of the present disclosure. In the present disclosure, schematic representations of the above terms do not necessarily refer to the same embodiment or example. Furthermore, the described specific features, structures, materials or characteristics may be combined in any manner in any one or more embodiments or examples.

The logic and/or blocks represented in the flowcharts or otherwise described herein. For example, the logic and/or blocks may be considered as a sequenced list of executable instructions for implementing logical functions and may be embodied in any computer-readable medium for use by an instruction execution system, apparatus, or device, or Used in conjunction with these instruction execution systems, devices or equipment. Such as computer-based systems, systems including processing modules, or other systems that can fetch and execute instructions from an instruction execution system, apparatus, or device. For the purposes of the present disclosure, a “computer-readable medium” may be any device that can contain, store, communicate, propagate or transmit a program for use or in conjunction with an instruction execution system, or device. More specific examples (non-exhaustive list) of computer-readable media include the following: electrical connection with one or more wires (electronic device), portable computer disk case (magnetic device), random access memory (RAM), Read Only Memory (ROM), Erasable and Editable Read Only Memory (EPROM or Flash Memory), Fiber Optic Devices, and Portable Compact Disc Read Only Memory (CDROM). In addition, the computer-readable medium may even be paper or other medium on which the program may be printed, as it may be possible, for example, by optically scanning the paper or other medium, followed by editing, interpretation or other means if necessary. The program is obtained electronically by processing and then stored in storage device 105.

The processor 110 may be a central processing unit (Central Processing Unit, CPU), and may also be other general-purpose processors 300, a digital signal processor 110 (Digital Signal Processor, DSP), an application specific integrated circuit (Application Specific Integrated Circuit, ASIC), Ready-made programmable gate array (Field-Programmable Gate Array, FPGA) or other programmable logic devices, discrete gate or transistor logic devices, discrete hardware components, etc. The general-purpose processor 110 may be a microprocessor 110 or the processor 110 may be any conventional processor 110 or the like.

It is understood that each part of the embodiments of the present disclosure may be realized by hardware, software, firmware or a combination thereof. In the embodiments described above, the blocks or the robot controlling method may be implemented by software or firmware stored in the storage device and executed by an instruction execution system. For example, if implemented in hardware, as in another embodiment, it can be implemented by any one or combination of the following techniques known in the art: Discrete logic circuits, ASICs with combinational logic gates, programmable gate arrays (PGAs), field programmable gate arrays (FPGAs), etc.

Those of ordinary skill in the art can understand that all or part of the steps carried by the method of the above-mentioned embodiments can be completed by instructing related hardware through a program, and the program can be stored in a computer-readable storage medium 500, and the program can be executed when the program is executed. When, one or a combination of the steps of the method embodiment is included.

The storage medium mentioned above may be a read-only memory, a magnetic disk or an optical disk, and the like.

Although the embodiments of the present disclosure have been shown and described above, it can be understood that the above embodiments are exemplary and should not be construed as limitations on the present disclosure. The embodiments are subject to changes, modifications, substitutions and variations.

It is understood that the division of modules described above is a logical functional division, and there can be another division in actual implementation. In addition, each functional module in each embodiment of the present disclosure may be integrated in the same processing unit, or each module may physically exist separately, or two or more modules may be integrated in the same unit. The above integrated modules can be implemented either in the form of hardware or in the form of hardware plus software functional modules. The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A positioning method applied to a robot, comprising:
obtaining a current local topology map and a full topology map, wherein the current local topology map is established based on objects in an environment currently observed by the robot, the full topology map is pre-established based on objects in a full environment in a preset area, the current local topology map comprises nodes representing the objects in the environment currently observed by the robot, and the full topology map comprises nodes representing the objects in the full environment;
matching the nodes in the current local topology map and the nodes in the full topology map, wherein the matching comprises determining a degree of association of at least one node pair to be associated, which is constructed by the nodes in the current local topology map and the nodes in the full topology map;
in response that the degree of association of the at least one node pair to be associated is greater than a threshold, determining that the at least one node pair to be associated is an associated node pair;
selecting, from a plurality of search branches, a search branch with a largest number of associated node pairs as a search branch with a highest matching degree; and
determining a current pose of the robot according to the search branch with the highest matching degree.

2. The method according to claim 1, wherein obtaining the full topology map comprises:
obtaining a full environment image and a full depth image;
establishing a full semantic map based on the full environment image and the full depth image, wherein the full semantic map comprises full point cloud information and first object type labels corresponding to the full point cloud information;
clustering the full point cloud information in the full semantic map according to the first object type labels, identifying each object, and obtaining a first bounding box of each object, wherein the first bounding box is an independent space corresponding to point clouds with same first object type label after clustering the point clouds;
taking each first bounding box as a node, and taking a connection line between two adjacent first bounding boxes as an edge to generate the full topology map, wherein a distance between the two adjacent first bounding boxes is less than a preset distance.

3. The method according to claim 2, wherein obtaining the current local topology map comprises:
obtaining a current environment image and a current depth image;
establishing a current semantic map according to the current environment image and the current depth image, wherein the current semantic map comprises current point cloud information and second object type labels corresponding to the current point cloud information;
clustering the current point cloud information in the current semantic map according to the second object type labels, identifying each object, and obtaining a second bounding box of each object, wherein the second bounding box is an independent space corresponding to point clouds with same second object type label after clustering the point clouds; and
taking each second bounding box as a node and taking a connection line between two adjacent second bounding boxes as an edge to generate the current local topology map, wherein a distance between the two adjacent second bounding boxes is less than the preset distance.

4. The method according to claim 3, wherein selecting, from the plurality of search branches, the search branch with the largest number of associated node pairs as the search branch with the highest matching degree comprises:
combining the current local topology map and the full topology map to construct a search interpretation tree, wherein the search interpretation tree comprises the plurality of search branches, and traversing each of the search branches;
constituting a second-layer node using each node in the current local topology map;
taking the second-layer node as a parent node, and constituting a third-layer node by taking each node in the full topology map as a child node of the second-layer node, wherein the second-layer node and the third-layer node constitute a first node pair of the search interpretation tree;
determining whether the first object type label corresponding to the node in the full topology map is the same as the second object type label corresponding to the node in the current local topology map in the first node pair;
in response that the first object type label corresponding to the node in the full topology map is different from the second object type label corresponding to the node in the current local topology map in the first node pair, ending a construction of a corresponding search branch;
in response that the first object type label corresponding to the node in the full topology map is the same as the second object type label corresponding to the node in the current local topology map in the first node pair, taking the third-layer node as the parent node, and constituting a fourth-layer node by taking all remaining nodes after removing nodes that appeared in an upstream branch of the search branch in the current local topology map as child nodes of the third-layer node; taking the fourth-layer node as the parent node, and constituting a fifth-layer node by taking all the remaining nodes in the full topology map after removing the nodes that appeared in the upstream branch of the search branch as child nodes of the fourth-layer node, wherein the fourth-layer node and the fifth-layer node constitute a second node pair of the search interpretation tree;
determining whether the first object type label corresponding to the node in the full topology map is the same as the second object type label corresponding to the node in the current local topology map in the second node pair; according to a distance and an angle between two current local topology map nodes in the first node pair and the second node pair and a distance and an angle between two full topology map nodes in a same search branch, obtaining a degree of association of a node pair to be associated formed by the first node pair and the second node pair;
in response that the first object type label corresponding to the node in the full topology map is different from the second object type label corresponding to the node in the current local topology map in the second node pair, or the degree of association is less than the threshold, ending the construction of the corresponding search branch;
in response that the first object type label corresponding to the node in the full topology map is the same as the second object type label corresponding to the node in the current local topology map in the second node pair, and the degree of association is greater than the threshold, continuing to traverse the node of the current local topology map and the full topology map; and
counting a number of associated node pairs of each search branch, and determining the search branch with the largest number of associated node pairs as the search branch with the highest matching degree.

5. The method according to claim 4, wherein before selecting, from the plurality of search branches, the search branch with the largest number of associated node pairs as the search branch with the highest matching degree, the method further comprises
combining the current local topology map and the full topology map to construct the search interpretation tree;
taking each node in the current local topology map as the second-layer node;
taking the second-layer node as the parent node, and constructing the third-layer node by taking each node in the full topology map as child nodes of the second-layer node;
taking the third-layer node as the parent node, and constructing the fourth-layer node by taking all the remaining nodes after removing the nodes that appeared in the upstream branch of the search branch in the current local topology map as child nodes of the third-layer node;
taking the fourth-layer node as the parent node, and constructing the fifth-layer node by taking all remaining nodes after removing the nodes that appeared in the upstream branch of the search branch in the full topology map as the child nodes of the fourth-layer node; and
by analogy, continuing to traverse the nodes of the current local topology map and the full topology map to construct the search interpretation tree.

6. The method according to claim 5, wherein the search interpretation tree comprises the plurality of search branches, and selecting, from the plurality of search branches, the search branch with the largest number of associated node pairs as the search branch with the highest matching degree comprises:
traversing each of the plurality of search branches;
in response that the search branch of the search interpretation tree comprising the associated node pair, determining the search branch as a matching branch; and in response that the search branch of the search interpretation tree not comprising the associated node pair, interrupting a search of the corresponding search branch; and
counting a number of associated node pairs of each matching branch, and determining the matching branch with the largest number of associated node pairs as the search branch with the highest matching degree.

7. The method according to claim 6, wherein “matching the nodes in the current local topology map and the nodes in the full topology map, wherein the matching comprises determining a degree of association of at least one node pair to be associated, which is constructed by the nodes in the current local topology map and the nodes in the full topology map” comprises:
determining whether a first node of the current local topology map and a first node of the full topology map belong to a same object type label, wherein the first node of the current local topology map and the first node of the full topology map construct a first node pair;
in response that the first node of the current local topology map and the first node of the full topology map belong to the same object type label, determining whether a second node of the current local topology map and a second node of the full topology map belong to the same object type label, wherein the second node of the current local topology map and the second node of the full topology map construct a second node pair; and
in response that the second node of the current local topology map and the second node of the full topology map belong to the same object type label, comparing a distance and an angle between the first node of the current local topology map and the second node of the current local topology map with a distance and an angle between the first node of the full topology map and the second node of the full topology map, and obtaining the degree of association of the node pair to be associated constructed by the first node pair and the second node pair; in response that the degree of association is greater than the threshold, determining the node pair to be associated as an associated node pair.

8. The method according to claim 5, wherein before combining the current local topology map and the full topology map to construct the search interpretation tree, the method further comprises:
calculating a size of the first bounding box of each object in the full topology map and a size of the second bounding box of each object in the current local topology map;
counting a number of objects corresponding to the first object type label in the full topology map to determine a first rarity rate and counting a number of objects corresponding to the second object type label in the current local topology map to determine a second rarity rate;
calculating a first random walk feature of each object in the full topology map and a second random walk feature of each object in the current local topology map;
according to the size of the first bounding box, the size of the second bounding box, the first rarity rate, the second rarity rate, the first random walk feature, and the second random walk feature, calculating a similarity of a topology node set of the current local topology map and the topology node set, wherein the topology node set comprises the first node of the full topology map and the second node of the current local topology map, and the first object type label corresponding to the first node is the same as the second object type label corresponding to the second node; and
determining a node pair whose similarity in the topology node set is higher than a preset similarity, taking the node of the node pair in the full topology map as a central node, and taking the central node and nodes within a preset range around the central node in the full topology map as a updated full topology map, and the updated full topology map being used to combine with the current local topology map to construct the search interpretation tree.

9. A robot, wherein the robot comprises a processor, the processor is configured to:
obtain a current local topology map and a full topology map, wherein the current local topology map is established based on objects in a current environment observed by the robot, the full topology map is pre-established based on objects in a full environment in a preset area, the current local topology map comprises nodes representing the objects in the environment currently observed by the robot, and the full topology map comprises nodes representing the objects in the full environment;
match the nodes in the current local topology map and the nodes in the full topology map, wherein the matching comprises determining a degree of association of at least one node pair to be associated, which is constructed by the nodes in the current local topology map and the nodes in the full topology map;
in response that the degree of association of the at least one node pair to be associated is greater than a threshold, determine that the at least one node pair to be associated is an associated node pair;
select, from a plurality of search branches, a search branch with a largest number of associated node pairs as a search branch with a highest matching degree; and
determine a current pose of the robot according to the search branch with the highest matching degree.

10. The robot according claim 9, wherein the processor is configured to:
obtain a full environment image and a full depth image captured by a camera device;
establish a full semantic map based on the full environment image and the full depth image, wherein the full semantic map comprises full point cloud information and first object type labels corresponding to the full point cloud information;
cluster the full point cloud information in the full semantic map according to the first object type labels, identifying each object, and obtain a first bounding box of each object, wherein the first bounding box is an independent space corresponding to point clouds with same first object type label after clustering the point clouds;
take each first bounding box as a node, and take a connection line between two adjacent first bounding boxes as an edge to generate the full topology map, wherein a distance between the two adjacent first bounding boxes is less than a preset distance.

11. The robot according claim 10, wherein the processor is configured to:
obtain a current environment image and a current depth image captured by the camera device;
establish a current semantic map according to the current environment image and the current depth image, wherein the current semantic map comprises current point cloud information and second object type labels corresponding to the current point cloud information;
cluster the current point cloud information in the current semantic map according to the second object type labels, identifying each object, and obtain a second bounding box of each object, wherein the second bounding box is an independent space corresponding to point clouds with same second object type label after clustering the point clouds; and
take each second bounding box as a node and taking a connection line between two adjacent second bounding boxes as an edge to generate the current local topology map, wherein a distance between the two adjacent second bounding boxes is less than the preset distance.

12. The robot according claim 10, wherein the processor is configured to;
combine the current local topology map and the full topology map to construct a search interpretation tree, wherein the search interpretation tree comprises the plurality of search branches, and traversing each of the search branches;
constitute a second-layer node using each node in the current local topology map;
take the second-layer node as a parent node, and constitute a third-layer node by taking each node in the full topology map as a child node of the second-layer node, wherein the second-layer node and the third-layer node constitute a first node pair of the search interpretation tree;
determine whether the first object type label corresponding to the node in the full topology map is the same as the second object type label corresponding to the node in the current local topology map in the first node pair;
in response that the first object type label corresponding to the node in the full topology map is different from the second object type label corresponding to the node in the current local topology map in the first node pair, end a construction of a corresponding search branch;
in response that the first object type label corresponding to the node in the full topology map is the same as the second object type label corresponding to the node in the current local topology map in the first node pair, take the third-layer node as the parent node, and constituting a fourth-layer node by taking all remaining nodes after removing nodes that appeared in an upstream branch of the search branch in the current local topology map as child nodes of the third-layer node; take the fourth-layer node as the parent node, and constitute a fifth-layer node by taking all the remaining nodes in the full topology map after removing the nodes that appeared in the upstream branch of the search branch as child nodes of the fourth-layer node, wherein the fourth-layer node and the fifth-layer node constitute a second node pair of the search interpretation tree;
determine whether the first object type label corresponding to the node in the full topology map is the same as the second object type label corresponding to the node in the current local topology map in the second node pair; according to a distance and an angle between two current local topology map nodes in the first node pair and the second node pair and a distance and an angle between two full topology map nodes in a same search branch, obtain a degree of association of a node pair to be associated formed by the first node pair and the second node pair;
in response that the first object type label corresponding to the node in the full topology map is different from the second object type label corresponding to the node in the current local topology map in the second node pair, or the degree of association is less than the threshold, end the construction of the corresponding search branch;
in response that the first object type label corresponding to the node in the full topology map is the same as the second object type label corresponding to the node in the current local topology map in the second node pair, and the degree of association is greater than the threshold, continue to traverse the node of the current local topology map and the full topology map; and
count a number of associated node pairs of each search branch, and determine the search branch with the largest number of associated node pairs as the search branch with the highest matching degree.

13. The robot according to claim 12, wherein the processor is configured to:
combine the current local topology map and the full topology map to construct the search interpretation tree;
take each node in the current local topology map as the second-layer node;
take the second-layer node as the parent node, and construct the third-layer node by taking each node in the full topology map as child nodes of the second-layer node;
take the third-layer node as the parent node, and construct the fourth-layer node by taking all the remaining nodes after removing the nodes that appeared in the upstream branch of the search branch in the current local topology map as child nodes of the third-layer node;
take the fourth-layer node as the parent node, and construct the fifth-layer node by taking all remaining nodes after removing the nodes that appeared in the upstream branch of the search branch in the full topology map as the child nodes of the fourth-layer node; and
by analogy, continue to traverse the nodes of the current local topology map and the full topology map to construct the search interpretation tree.

14. The robot according claim 13, wherein the search interpretation tree comprises the plurality of search branches, and the processor is configured to:
traverse each of the plurality of search branches;
in response that the search branch of the search interpretation tree comprising the associated node pair, determine the search branch as a matching branch; and in response that the search branch of the search interpretation tree not comprising the associated node pair, interrupt a search of the corresponding search branch; and
count a number of associated node pairs of each matching branch, and determine the matching branch with the largest number of associated node pairs as the search branch with the highest matching degree.

15. The method according to claim 14, wherein the processor is configured to:
determine whether a first node of the current local topology map and to first node of the full topology map belong to the same object type label, wherein the first node of the current local topology map and the first node of the full topology map construct a first node pair;
in response that the first node of the current local topology map and the first node of the full topology map belong to the same object type label, determine whether a second node of the current local topology map and a second node of the full topology map belong to the same object type label, wherein the second node of the current local topology map and the second node of the full topology map construct a second node pair; and
in response that the second node of the current local topology map and the second node of the full topology map belong to a same object type label, compare a distance and an angle between the first node of the current local topology map and the second node of the current local topology map with a distance and an angle between the first node of the full topology map and the second node of the full topology map, and obtain the degree of association of the node pair to be associated constructed by the first node pair and the second node pair; in response that the degree of association is greater than a threshold, determine the node pair to be associated as an associated node pair.

16. The robot according claim 13, wherein the processor is configured to:
calculate a size of the first bounding box of each object in the full topology map and a size of the second bounding box of each object in the current local topology map;
count a number of objects corresponding to the first object type label in the full topology map to determine a first rarity rate and count a number of objects corresponding to the second object type label in the current local topology map to determine a second rarity rate;
calculate a first random walk feature of each object in the full topology map and a second random walk feature of each object in the current local topology map;
according to the size of the first bounding box, the size of the second bounding box, the first rarity rate, the second rarity rate, the first random walk feature, and the second random walk feature, calculate a similarity of a topology node set of the current local topology map and the topology node set, wherein the topology node set comprises the first node of the full topology map and the second node of the current local topology map, and the first object type label corresponding to the first node is the same as the second object type label corresponding to the second node; and
determine a node pair whose similarity in the topology node set is higher than a preset similarity, taking the node of the node pair in the full topology map as a central node, and take the central node and nodes within a preset range around the central node in the full topology map as a updated full topology map, and the updated full topology map being used to combine with the current local topology map to construct the search interpretation tree.

17. A non-transitory storage medium, wherein the non-transitory storage medium stores a computer program, when the computer program is executed by a processor, the processor is caused to perform a positioning method, the positioning method comprises:
obtaining a current local topology map and a full topology map, wherein the current local topology map is established based on objects in an environment currently observed by the robot, the full topology map is pre-established based on objects in a full environment in a preset area, the current local topology map comprises nodes representing the objects in the environment currently observed by the robot, and the full topology map comprises nodes representing the objects in the full environment;
matching the nodes in the current local topology map and the nodes in the full topology map, wherein the matching comprises determining a degree of association of at least one node pair to be associated, which is constructed by the nodes in the current local topology map and the nodes in the full topology map;
in response that the degree of association of the node pair to be associated is greater than a threshold, determining that the at least one node pair to be associated is an associated node pair;
selecting, from a plurality of search branches, a search branch with a largest number of associated node pairs as a search branch with a highest matching degree; and
determining a current pose of the robot according to the search branch with the highest matching degree.

18. The non-transitory storage medium according to claim 17, wherein obtaining the full topology map comprises:
obtaining a full environment image and a full depth image;
establishing a full semantic map based on the full environment image and the full depth image, wherein the full semantic map comprises full point cloud information and first object type labels corresponding to the full point cloud information;
clustering the full point cloud information in the full semantic map according to the first object type labels, identifying each object, and obtaining a first bounding box of each object, wherein the first bounding box is an independent space corresponding to point clouds with same first object type label after clustering the point clouds;
taking each first bounding box as a node, and taking a connection line between two adjacent first bounding boxes as an edge to generate the full topology map, wherein a distance between the two adjacent first bounding boxes is less than a preset distance.

19. The non-transitory storage medium according to claim 18, wherein obtaining the current local topology map comprises:
obtaining a current environment image and a current depth image;
establishing a current semantic map according to the current environment image and the current depth image, wherein the current semantic map comprises current point cloud information and second object type labels corresponding to the current point cloud information;
clustering the current point cloud information in the current semantic map according to the second object type labels, identifying each object, and obtaining a second bounding box of each object, wherein the second bounding box is an independent space corresponding to point clouds with same second object type label after clustering the point clouds; and
taking each second bounding box as a node and taking a connection line between two adjacent second bounding boxes as an edge to generate the current local topology map, wherein a distance between the two adjacent second bounding boxes is less than the preset distance.

20. The non-transitory storage medium according to claim 19, wherein selecting, from the plurality of search branches, the search branch with the largest number of associated node pairs as the search branch with the highest matching degree comprises:
combining the current local topology map and the full topology map to construct a search interpretation tree, wherein the search interpretation tree comprises the plurality of search branches, and traversing each of the search branches;
constituting a second-layer node using each node in the current local topology map;
taking the second-layer node as a parent node, and constituting a third-layer node by taking each node in the full topology map as a child node of the second-layer node, wherein the second-layer node and the third-layer node constitute a first node pair of the search interpretation tree;
determining whether the first object type label corresponding to the node in the full topology map is the same as the second object type label corresponding to the node in the current local topology map in the first node pair;
in response that the first object type label corresponding to the node in the full topology map is different from the second object type label corresponding to the node in the current local topology map in the first node pair, ending a construction of a corresponding search branch;
in response that the first object type label corresponding to the node in the full topology map is the same as the second object type label corresponding to the node in the current local topology map in the first node pair, taking the third-layer node as the parent node, and constituting a fourth-layer node by taking all remaining nodes after removing nodes that appeared in an upstream branch of the search branch in the current local topology map as child nodes of the third-layer node; taking the fourth-layer node as the parent node, and constituting a fifth-layer node by taking all the remaining nodes in the full topology map after removing the nodes that appeared in the upstream branch of the search branch as child nodes of the fourth-layer node, wherein the fourth-layer node and the fifth-layer node constitute a second node pair of the search interpretation tree;
determining whether the first object type label corresponding to the node in the full topology map is the same as the second object type label corresponding to the node in the current local topology map in the second node pair; according to a distance and an angle between two current local topology map nodes in the first node pair and the second node pair and a distance and an angle between two full topology map nodes in a same search branch, obtaining a degree of association of a node pair to be associated formed by the first node pair and the second node pair;
in response that the first object type label corresponding to the node in the full topology map is different from the second object type label corresponding to the node in the current local topology map in the second node pair, or the degree of association is less than the threshold, ending the construction of the corresponding search branch;
in response that the first object type label corresponding to the node in the full topology map is the same as the second object type label corresponding to the node in the current local topology map in the second node pair, and the degree of association is greater than the threshold, continuing to traverse the node of the current local topology map and the full topology map; and
counting a number of associated node pairs of each search branch, and determining the search branch with the largest number of associated node pairs as the search branch with the highest matching degree.
